(19) United States
(12) Patent Application Publication
(10) Pub. No.: US 2017/0259409 A1
(43) Pub. Date: Sep. 14, 2017

(54) WINGNUT KNOBS

(71) Applicant: Joseph Ferrise, Allen Park, MI (US)

(72) Inventor: Joseph Ferrise, Allen Park, MI (US)

(21) Appl. No.: 15/458,312

(22) Filed: Mar. 14, 2017

Related U.S. Application Data
(60) Provisional application No. 62/307,950, filed on Mar. 14, 2016.

(51) Int. Cl. B25B 13/50

(52) U.S. Cl. CPC B25B 13/5091

(57) ABSTRACT

A wingnut knob used for loosening and/or tightening a wingnut. The wingnut knob is placed over the outside surface of a wingnut so as to provide a larger grip surface area and to increase leverage for turning the wingnut. The wingnut knob generally includes an elongated upper knob portion and a corresponding bottom portion configured to hold a wingnut. The knob includes an inner surface and an opposed outer surface, the outer surface having a gripping portion, the inner surface having geometry configured to match the outer surface of the wingnut and a set screw extending through both the outer surface and the inner surface of the knob, the set screw configured to abut the wingnut when tightened wherein the knob is removably connected to the wingnut upon loosening of the set screw.

### CROSS-REFERENCE TO RELATED APPLICATIONS

This application claims priority of U.S. Provisional Patent Application Ser. No. 62/307,950 filed Mar. 14, 2016, which is incorporated herein by reference.

### TECHNICAL FIELD

The present specification relates generally to tools, more specifically, a tool for assisting in turning a wingnut.

### BACKGROUND

Wingnuts are well known in the art. A wingnut or wing nut is a type of nut with two large metal “wings.” In other terms, a wingnut is a bolt nut with a plurality of wings to allow tightening with the finger and thumb. The term “wingnut” is and may be used interchangeably with “wing nut” when being reference herein as both spellings are widely and commonly accepted in the art.

The wings are disposed on either side of the nut so that the nut can be easily tightened and loosened. The wingnuts are typically made of a metal but may optionally be made out of a hard plastic or polymer material. However, the wings of the wingnuts are frequently small and difficult to grasp. In these cases the user may have a difficult time turning the wingnut by the wings if the wingnut and corresponding bolt have become rusted or otherwise stuck due to time or very tight tightening. Accordingly, there exists a need in the art to provide a tool to assist in loosening and/or tightening a wingnut.

### SUMMARY

In one embodiment, a knob for connection to a wingnut is provided where the wingnut includes an outer surface. In this embodiment, the knob includes an inner surface and an opposed outer surface, the outer surface having a gripping portion, the inner surface having geometry configured to match the outer surface of the wingnut and a set screw extending through both the outer surface and the inner surface of the knob, the set screw configured to abut the wingnut when tightened wherein the knob is removably connected to the wingnut upon loosening of the set screw. In this embodiment, the knob further includes an upper portion and a lower portion where the upper portion is a handle configured to allow a user to rotate the knob and wherein the handle is elongated. Furthermore, the lower portion may include an opening to a cavity, the cavity extending into the knob. The cavity is configured to tightly secure the wingnut to the knob.

In other embodiments, an assembly is provided including a wingnut, a knob configured to removably connect to the wingnut, the knob comprising an inner surface and an opposed outer surface, the outer surface having a gripping portion, the inner surface having geometry configured to match the outer surface of the wingnut and a set screw extending through both the outer surface and the inner surface of the knob, the set screw configured to abut the wingnut when tightened wherein the knob is removably connected to the wingnut upon loosening of the set screw. In this embodiment, the knob further includes an upper portion and a lower portion where the upper portion is a handle configured to allow a user to rotate the knob and wherein the handle is elongated. Furthermore, the lower portion may include an opening to a cavity, the cavity extending into the knob. The cavity is configured to tightly secure the wingnut to the knob.

In yet another embodiment, a knob for a wingnut is provided having an upper portion and a lower portion, the upper portion having a handle, the lower portion having a cavity, the cavity configured to removably connect to the wingnut. In this embodiment, the upper portion is a handle configured to allow a user to rotate the knob and wherein the handle is elongated. Furthermore, the lower portion may include an opening to a cavity, the cavity extending into the knob. The cavity is configured to tightly secure the wingnut to the knob.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an exploded perspective view of the wingnut knob and corresponding wingnut according to one or more embodiments shown and described herein;

FIG. 2 illustrates an bottom perspective view of the wingnut knob according to one or more embodiments shown and described herein;

FIG. 3 illustrates a side view of the wingnut knob according to one or more embodiments shown and described herein;

FIG. 4 illustrates a bottom view of the wingnut knob according to one or more embodiments shown and described herein; and

FIG. 5 depicts an a partial cross-sectional view of an installed wingnut knob and corresponding set screws knob according to one or more embodiments shown and described herein.

### DETAILED DESCRIPTION

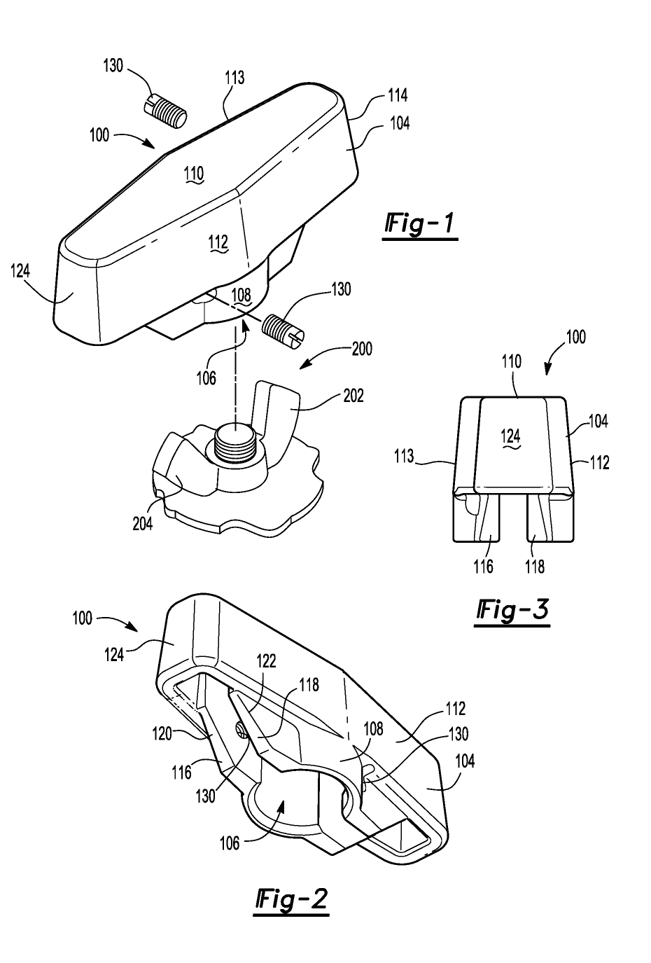

FIG. 1 generally depicts a wingnut knob used for loosening and/or tightening a wingnut. The wingnut knob is placed over the outside surface of a wingnut so as to provide a larger grip surface area and to increase leverage for turning the wingnut. The wingnut knob generally includes an elongated upper knob portion and a corresponding bottom portion configured to hold a wingnut.

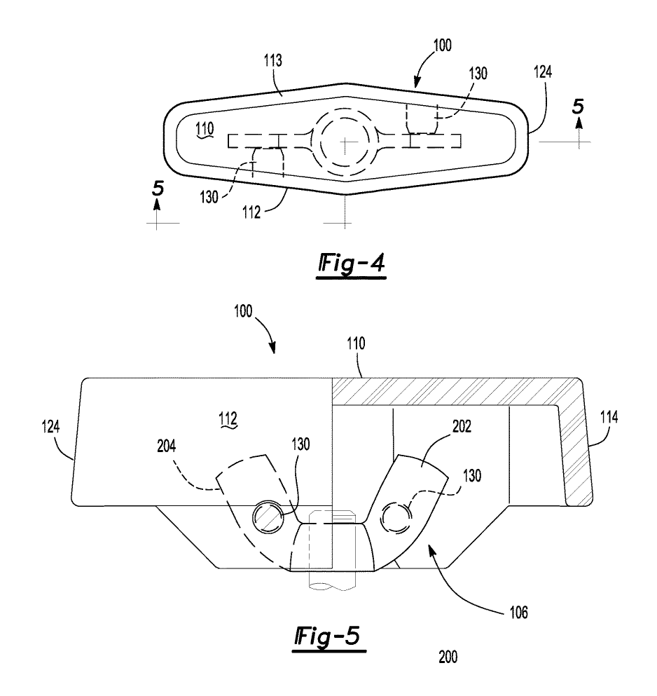

Referring now to FIGS. 1-5, a wingnut knob or knob 100 includes a grip portion 104 and a connecting portion 108. The connecting portion 108 includes an aperture or receiving area 106. The receiving area 106 is configured to connect with an outer surface of a wingnut. The gripping portion 104 includes an upper surface 110 and side surfaces 112, 124. The surfaces 112, 124 are generally curved and smooth to ergonomically mate with the hands of a user.

The knob 100 further includes side portions 116, 118 extending away from the gripping portion 104 thereby forming the connecting portion 108. The side portions 116, 118 include angled edges 120, 122 extending away from the gripping portion 104. The side portions 116, 118 are spaced apart from each other to form the receiving portion 106 configured to hold a wingnut. The receiving portion 104 includes sidewalls 132, 134. The sidewalls 132, 134 are generally curved and configured to accept the outer surface of a wingnut. A wingnut 200 includes wings 202, 204. The wings 202, 204 include respective outer surfaces 208, 210. A base portion 212 is also provided on the wingnut where the wings 202, 204 extend upwards and away from the base portion 212.

The knob 100 may further include a set screw 130 extending through the receiving portion 108. The set screw 130 is configured to connect directly to and abut a wingnut, such as the wingnut 200. The set screw 130 is configured to further secure the knob 100 to the wingnut 200. An aperture extends through the receiving portion 108 where a screw 130 may extend therethrough. The screw includes a proximal end and a distal end where the distal end is configured to abut directly to the wingnut 200. The screw may be tightened by hand or by a general screwdriver.

In the present embodiment, a plurality of set screws are provided. The second set screw is provided to further secure the knob 100 to the wingnut 200. The set screw are critical to the use of the present embodiment. In other embodiments where no set screw is provided, the knob 100 frequently falls off inadvertently from the wingnut 200. This makes it impossibly difficult to use the knob 100. The inclusion of the set screw or plurality of set screws extending through the sidewalls of the knob 100 all the user to semi-permanently use the knob 100 over the wingnut 200. The user may then leave the knob 100 over the wingnut 200 or remove it for use on a separate tool.

In typical embodiments, the wingnut 200 is made of a metal material. In other embodiments, the wingnut 200 is made of a plastic, plastic-like, polymer or polymer-like material. In the present embodiment, the knob 100 is made of a rubber, plastic, plastic-like, polymer or polymer-like material. Any other suitable material or composition having like properties of strength and resiliency may also be used.

In the present embodiment, the knob 100 is formed by a molding or injection molding process. The knob 100 may also be stamped or otherwise similarly formed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A knob for connection to a wingnut, the wingnut having an outer surface, the knob comprising:
an inner surface and an opposed outer surface,
the outer surface having a gripping portion,
the inner surface having geometry configured to match the outer surface of the wingnut; and
a set screw extending through both the outer surface and the inner surface of the knob, the set screw configured to abut the wingnut when tightened;
wherein the knob is removably connected to the wingnut upon loosening of the set screw.

2. The knob of claim 1 wherein the knob further includes an upper portion and a lower portion.

3. The knob of claim 2 wherein the upper portion is a handle configured to allow a user to rotate the knob.

4. The knob of claim 3 wherein the handle is elongated.

5. The knob of claim 2 wherein the lower portion includes an opening to a cavity, the cavity extending into the knob.

6. The knob of claim 5 wherein the cavity is configured to tightly secure the wingnut to the knob.

7. An assembly comprising:
a wingnut;
a knob configured to removably connect to the wingnut, the knob comprising an inner surface and an opposed outer surface, the outer surface having a gripping portion, the inner surface having geometry configured to match the outer surface of the wingnut; and
a set screw extending through both the outer surface and the inner surface of the knob, the set screw configured to abut the wingnut when tightened;
wherein the knob is removably connected to the wingnut upon loosening of the set screw.

8. The knob of claim 7 wherein the knob further includes an upper portion and a lower portion.

9. The knob of claim 8 wherein the upper portion is a handle configured to allow a user to rotate the knob.

10. The knob of claim 9 wherein the handle is elongated.

11. The knob of claim 8 wherein the lower portion includes an opening to a cavity, the cavity extending into the knob.

12. The knob of claim 11 wherein the cavity is configured to tightly secure the wingnut to the knob.

13. A knob for a wingnut comprising:
an upper portion and a lower portion, the upper portion having a handle, the lower portion having a cavity, the cavity configured to removably connect to the wingnut.

14. The knob of claim 13 wherein the upper portion is a handle configured to allow a user to rotate the knob.

15. The knob of claim 14 wherein the handle is elongated.

16. The knob of claim 13 wherein the lower portion includes an opening to a cavity, the cavity extending into the knob.

17. The knob of claim 16 wherein the cavity is configured to tightly secure the wingnut to the knob.

18. The knob of claim 13 wherein a set screw is provided extending through a sidewall of the knob, the set screw extending through both an inner surface and an outer surface of the knob, the set screw configured to abut the wingnut when in an installed position.
